(19) United States
(12) Patent Application Publication
(10) Pub. No.: US 2008/0124018 A1
(43) Pub. Date: May 29, 2008

(54) Pedal Crank Bearing or Hub Bearing Arrangement

(75) Inventors: Jesko-Henning Tanke, Schweinfurt (DE); Bettina Stoyke, Schonungen (DE); Bernd Muesing, Wuerzburg (DE)

Correspondence Address: BUCHANAN, INGERSOLL & ROONEY PC, POST OFFICE BOX 1404, ALEXANDRIA, VA, 22313-1404, US

(73) Assignee: AB SKF, Goteborg (SE)

(21) Appl. No.: 11/662,959

(22) PCT Filed: Sep. 9, 2005
(86) PCT No.: PCT/EP05/09698

§ 371 Date: Sep. 11, 2007

(30) Foreign Application Priority Data
Sep. 15, 2004 (DE) 10 2004 045 014.5

(51) Int. Cl. B60B 27/02; F16C 13/00

(52) U.S. Cl. 384/545

(57) ABSTRACT

The invention concerns a pedal assembly bearing or hub bearing for a bicycle. The inventive assembly comprises two antifriction bearings mutually spaced apart and capable of being arranged in a housing of a pedal assembly bearing or wheel bearing of the bicycle. Each antifriction bearing comprises an inner ring having a raceway for the rolling elements, as well as an outer ring having a raceway for the rolling elements, the rolling elements being placed between their respective raceways of the inner ring or of the outer ring. To achieve a high bearing surface while providing for low production costs. Therefore, the inner ring and the outer ring of the two bearings are both produced as compact elements, the outer ring having a tubular shape. An antifriction bearing is produced as roller bearing while the other antifriction bearing is produced as cylindrical roller bearing.

### TECHNICAL FIELD

The invention relates to a pedal crank bearing or hub bearing arrangement for a bicycle which has two antifriction bearings which are located at an axial distance from one another and which can be arranged in the pedal crank bearing or wheel bearing housing of the bicycle, each antifriction bearing having an inner ring with a track for the rolling bodies and an outer ring with a track for the rolling bodies and the rolling bodies being located between their respective tracks of the inner ring and outer ring.

### BACKGROUND DISCUSSION

Bearing arrangements of this type have been known for a long time in the prior art.

DE 296 01 861 U1 discloses a bearing arrangement for a bicycle, in which between the axle and the hub body there are two bearings at an axial distance, with which the hub is held in position relative to the axle. To axially fix the bearings on the axle, it has bearing collars adjoined axially by the bearings.

In order to achieve stable support of the hub on the axle, U.S. Pat. No. 6,095,691 calls for one bearing site to be made as a double-row, deep-groove ball bearing, while there is a needle bearing for the other bearing site.

A single-row, deep-groove ball bearing for one bearing site and a needle bearing for the other bearing site are proposed for a bearing arrangement which is known from WO 98/03391 and from DE 90 10 055 U1. DE 94 19 150 U1 uses this approach, here the axle in the region between the bearing points being a tube with a relatively large diameter which has a bore which is much larger than in the region of the side fastening elements.

DE 37 06 167 A1 finally discloses a generic bicycle bearing arrangement in which one bearing site is made as a deep-groove ball bearing and the other as a cylindrical roller bearing. In this case it is provided that the two bearings are pressed opposite one another into the housing opening of the pedal crank bearing housing.

The known bearing arrangements for pedal crank bearings and wheel hubs of bicycles to some extent do not adequately enable accommodation of high bearing forces over a long period of use. If the problem is resolved by multirow bearings, not only do production costs rise considerably, but also the friction moment rises disadvantageously in these bearings. Often the precision of the bearing arrangement does not meet requirements. Another important criterion in the assessment of the bearing arrangement is the cost in installation; in this respect likewise some of the existing designs can likewise be considered disadvantageous.

Therefore the object of the invention is to develop a bearing arrangement of the initially mentioned type such that the cited disadvantages are overcome. It should therefore be ensured that large bearing forces can be accommodated with high precision and a low friction moment of the bearing arrangement, and the installation cost for installation of the bearing arrangement in the bicycle should remain as low as possible.

### SUMMARY

This object is achieved by the invention in that both the inner ring and also the outer ring of the two antifriction bearings are made as integral components, the outer ring being made as a tubular component and one antifriction bearing being made as a ball bearing and the other being made as a cylindrical roller bearing.

Advantageously the inner ring of the two antifriction bearings is made as a tubular component. The ball bearing is preferably a deep-groove ball bearing. The bearing site provided with the ball bearing can be made as a fixed bearing; furthermore the bearing point provided with the cylindrical roller bearing can be made as a movable bearing.

To increase the bearing capacity of the bearing arrangement, it can be provided that in addition besides the ball bearing there is another roller bearing, especially a cylindrical roller bearing.

As is conventional at least in the case of a pedal crank bearing, the inner ring which is made as a tube in its two axial end regions can have connecting elements for positive interaction with one pedal crank at a time. The connecting elements can be multi-spline profiles or toothed profiles.

In order to be able to accommodate higher bearing forces on the side of the pedal bearing arrangement on which the sprocket wheel is mounted, there is preferably a cylindrical roller bearing here.

In order to achieve a light and still stable bearing arrangement, it is advantageously provided that the inner ring is formed from a tube which has a bore diameter which is essentially constant over its entire axial extension.

As an alternative version, it can be provided that the inner ring is formed from a tube which in its axial end regions has a smaller bore diameter than in its middle region. In this connection the smaller bore diameter can be at most 60%, preferably at most half, of the bore diameter in the middle region. The axial end sections with a smaller bore diameter can extend at most over 25% of the entire axial length of the inner ring, and a symmetrical configuration of the inner ring can be provided. Then the greater diameter therefore extends at least over 50% of the axial extension of the inner ring in the middle region of the ring.

Furthermore, with respect to lightweight construction, it has proven effective if the inner ring between the two tracks has a wall thickness which has been reduced relative to the wall thickness or the outside diameter at the location of the tracks and/or a reduced outside diameter. Similarly, the inner ring axially outside the two tracks can have a wall thickness which has been reduced relative to the wall thickness or to the outside diameter at the location of the tracks and/or a reduced outside diameter. Accordingly therefore the bearing sites with their tracks constitute a thickened tube section.

Accordingly, for purposes of a lightweight, stable structure it can be provided that the outer ring between the two tracks has a wall thickness which has been reduced relative to the wall thickness or to the outside diameter at the location of the tracks and/or a reduced outside diameter.

In order to a ensure a movable bearing function of the bearing site provided with the cylindrical roller bearing, it can finally be provided that the cylinder rollers are arranged with axial play on their track in the outer ring. The axial play can be between 0.1 and 0.3 mm.

With the proposed bearing arrangement, a compact and easily installed unit is formed which has high inherent stability and therefore enables a precise bearing arrangement. Especially in installation it is unnecessary to axially adjust the two bearing sites with reference to one another.

High bearing forces can be accommodated over a long interval of use.

A small friction moment is achieved by only two rows of bearings being provided.

The axial clearance of the bearing arrangement is defined solely by the bearing site provided with the ball bearing. Axial twisting in the bearing is prevented by bearing setting which does not take place.

Fouling is furthermore reduced by the tubular outer ring which jackets the entire bearing arrangement.

### BRIEF DESCRIPTION OF THE DRAWING FIGURES

Embodiments of the invention are shown in the drawings.

FIG. 1 shows a pedal crank bearing arrangement of a bicycle in a side view, shown with half a side cut away,

FIG. 2 shows an alternative configuration of the pedal crank bearing arrangement as shown in FIG. 1, uncut, and

FIG. 3 shows the representation as shown in FIG. 2, cut away.

### DETAILED DESCRIPTION

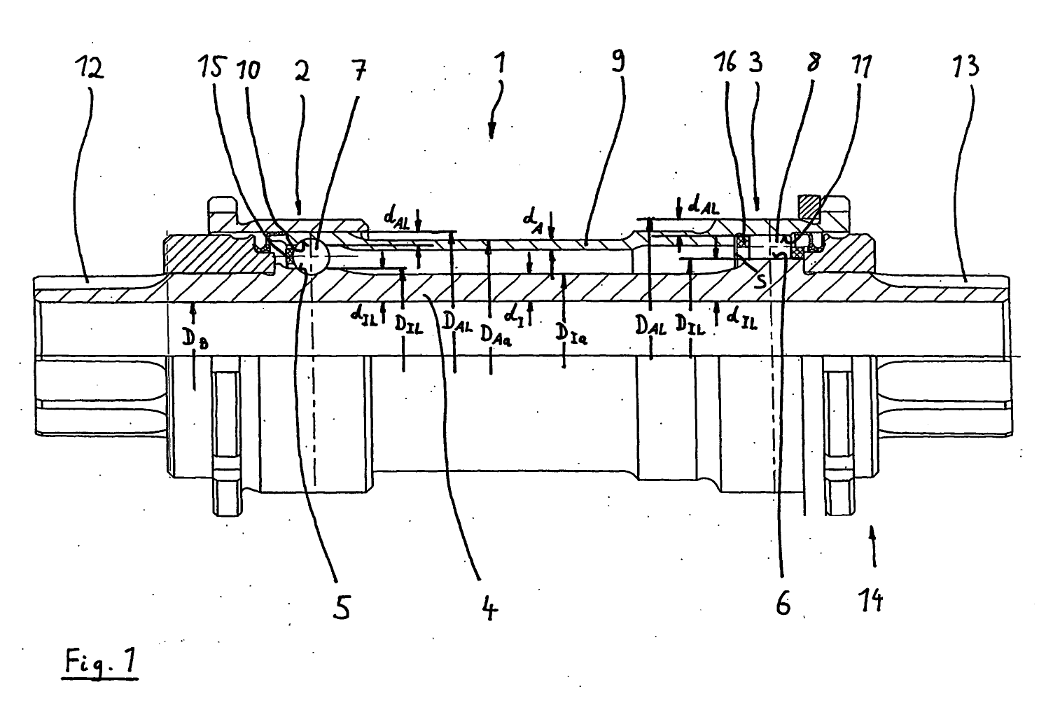

The pedal crank bearing arrangement 1 as shown in FIG. 1 is made as a compact unit. It has two bearing sites which are made on one side as an antifriction bearing 2 in the form of a deep-groove ball bearing and on the other side as an antifriction bearing 3 in the form of a cylindrical roller bearing.

The two bearings 2, 3 both have a common inner ring 4 and a common outer ring 9. The two bearing rings 4, 9 are made tubular. The inner ring 4 is made as a tube with a bore diameter D_{B}; on the outer periphery of the inner ring 4 the two tracks 5 (for the deep-groove ball bearing) and 6 (for the cylindrical roller bearing) are ground in.

Accordingly, the outer ring 9 which is made as a tube in its inner bore region has ground-in tracks 10 (for the deep-groove ball bearing) and 11 (for the cylindrical roller bearing).

Between the tracks 5 and 10 rolling bodies 7 in the form of balls are positioned. In addition, between the tracks 6 and 11 rolling bodies 8 in the form of cylinder rollers are positioned.

Conventionally there are cages 15 (for the deep-groove ball bearing 2) and 16 (for the cylindrical roller bearing 3).

The tubularly made inner ring 4 in its axial end regions furthermore has connecting elements 12 and 13 which are made for positive connection to pedal cranks.

In the installed state of the bearing arrangement the sprocket wheel is attached at the axial position labelled 14. There is a cylindrical roller bearing 3 here because higher forces are applied to the bearing arrangement at this location.

So that the forces acting on the bearing arrangement can be optimally accommodated, however at the same time a lightweight structure of the bearing arrangement is ensured—which is especially important in a bicycle—the inner ring 4 and the outer ring 9 are made as follows:

The tubular rings 4, 9 in the region of the bearing sites, i.e. where the tracks 5, 6, 10, 11 are ground in, have a site which is thickened relative to the remaining course of the tube. The wall thickness d_{IL} of the tubular inner ring 4 in the region of the track 5 and 6 is therefore greater than the wall thickness d_{I} which otherwise the inner ring 4 has. This applies both between the bearing sites and also axially outside of the bearing sites in the direction to the connecting elements 12, 13.

Furthermore, the outside diameter of the inner ring 4 in the region of the tracks 5, 6 with the recorded value D_{IL} is greater than the outside diameter in the region between the tracks and bearing sites which is given with D_{Ia}.

The corresponding or analogous arrangement applies to the tubular outer ring 9.

The wall thickness d_{AL} of the outer ring 9 in the region of the track 10 and 11 is greater than the wall thickness d_{A} which the outer ring 9 has otherwise. Furthermore the outside diameter of the outer ring 9 in the region of the tracks 10, 11 with the entered value D_{AL} is greater than the outside diameter in the region between the tracks or bearing sites which is given with D_{Aa}.

Thus, for given material use maximum stiffness of the bearing arrangement 1 is achieved.

So that the antifriction bearing 3 which is made as a cylindrical roller bearing always performs the task of a movable bearing, there is play s for the cylinder rollers 8 which is between 0.1 and 0.3 mm, preferably roughly 0.2 mm. There is play s here between the axial shoulder in the outer ring 9 and the cage 16 of the cylindrical roller bearing 3. The cylinder rollers 8 can therefore move within the framework of the play s in the axial direction; axial forces are therefore not transmitted by the cylindrical roller bearing.

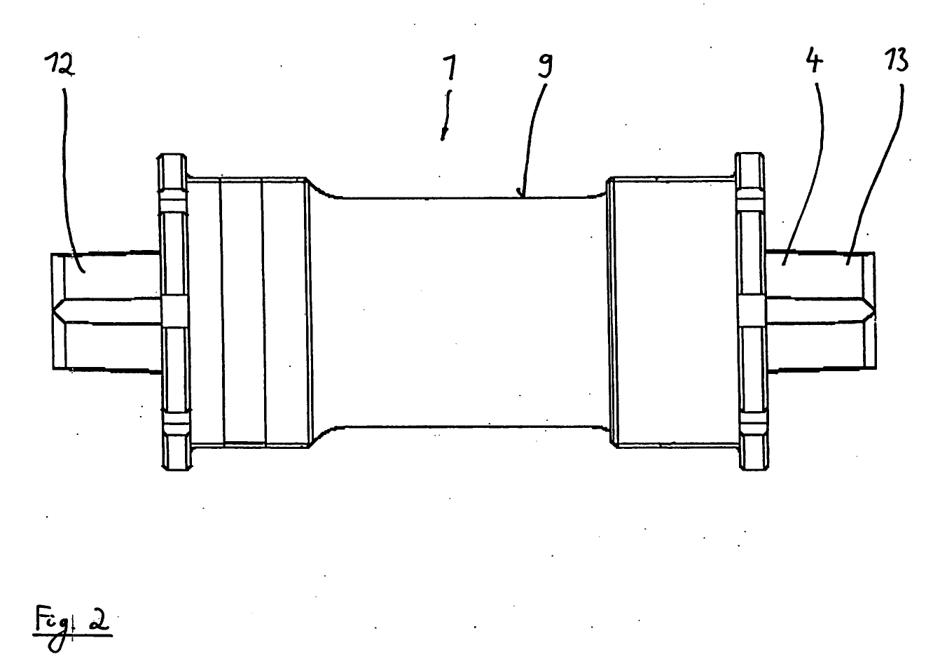

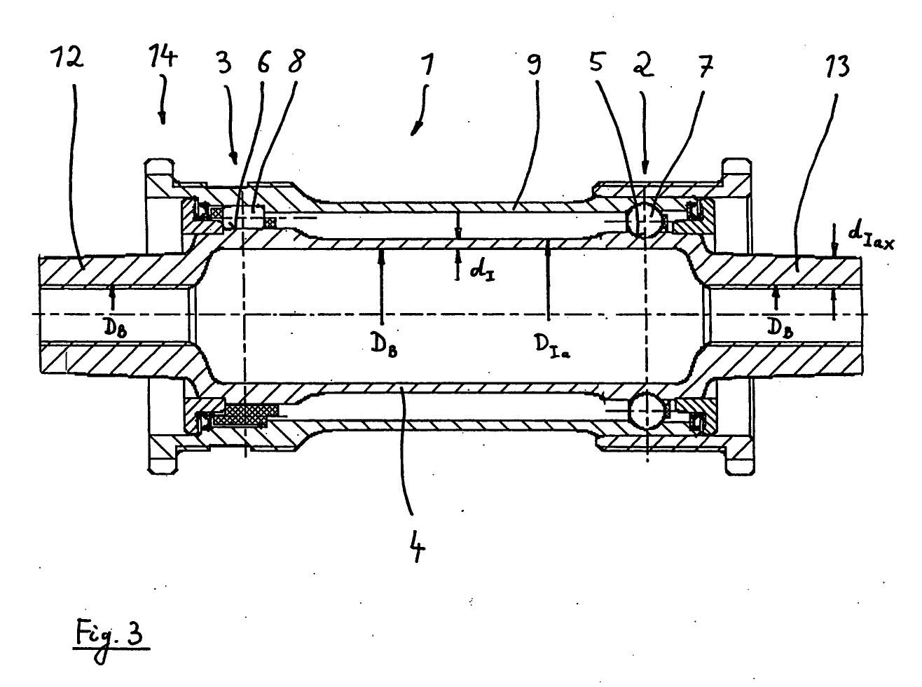

The configuration of the pedal crank bearing or wheel hub bearing arrangement 1 as shown in FIG. 2 and FIG. 3 differs from the embodiment as shown in FIG. 1 among others in that the bore diameter D_{B} is not constant over the axial extension of the inner ring 4, but is much smaller in the axial end regions than in the middle region.

The inner ring 4 here also consists of a tube. The bore diameter D_{B} which is smaller in at least one axial end region—preferably in the two axial end regions—is at most 60%, preferably at most 50% of the bore diameter D_{B} in the middle region. The axial end sections with a smaller bore diameter D_{B} extend at most over 25% of the total axial length of the inner ring 4. In this connection, in the embodiment there is a symmetrical configuration of the inner ring 4. Thus the greater diameter D_{B} here extends at least over 50% of the axial extension of the inner ring 4 in the middle region of the ring.

As can be furthermore seen, the reduction of the bore diameter D_{B}, originating from the middle, takes effect only outside the tracks 5 and 6.

For the other geometrical parameters which were explained in conjunction with the embodiment as shown in FIG. 1, what is analogous applies here. Here it is provided that for purposes of lightweight construction the inner ring 4 between the two tracks 5, 6 has a wall thickness which has been reduced relative to the wall thickness or the outside diameter at the location of the tracks and/or a reduced outside diameter.

In the approach as shown in FIG. 2 and FIG. 3, it is noteworthy that the wall thickness d_{Iax} of the tubular inner ring 4 in the two axial end regions is much greater than the wall thickness d_{I} in the middle region of the inner ring 4. The wall thickness d_{Iax} in the axial end region is preferably at least twice the value in the middle region—with a simultaneously reduced outside diameter D_{Ia} in the axial end region. Thus an especially stable structure is possible.

1-16. (canceled)

17. Pedal crank bearing arrangement or hub bearing arrangement for a bicycle comprising:
two antifriction bearings located at an axial distance from one another and adapted to be arranged in a pedal crank bearing housing or wheel bearing housing of the bicycle;
an inner ring;
an outer ring;
each of the antifriction bearing comprising rolling bodies positioned in respective tracks of the inner ring and the outer ring so that the rolling bodies are located between the respective tracks of the inner ring and outer ring;
both the inner ring and the outer ring being made as integral components, with the outer ring being made as a tubular component; and
one of the antifriction bearings being a ball bearing and the other antifriction bearing being a cylindrical roller bearing.

18. Bearing arrangement as claimed in claim 17, wherein the inner ring is a tubular component.

19. Bearing arrangement as claimed in claim 17, wherein the ball bearing is a deep-groove ball bearing.

20. Bearing arrangement as claimed in claim 17, wherein a bearing site provided with the ball bearing is a fixed bearing.

21. Bearing arrangement as claimed in claim 17, wherein a bearing site provided with the cylindrical roller bearing is a movable bearing.

22. Bearing arrangement as claimed in claim 17, wherein the inner ring, at both axial end regions, includes a connecting element for positive connection to a pedal crank.

23. Bearing arrangement as claimed in claim 22, wherein each of the connecting elements comprises a multi-spline profile or a toothed profile.

24. Bearing arrangement as claimed in claim 17, wherein a sprocket wheel is adapted to be mounted adjacent one end region of the bearing arrangement, the cylindrical roller bearing being positioned closer to the one end region of the bearing arrangement that the ball bearing.

25. Bearing arrangement as claimed in claim 17, wherein the inner ring is a tube possessing a bore diameter which is constant over an entire axial extent of the inner ring.

26. Bearing arrangement as claimed in claim 17, wherein the inner ring is a tube comprising opposite axial end regions which possess a smaller bore diameter than in a middle region of the tube.

27. Bearing arrangement as claimed in claim 17, wherein the inner ring possesses a wall thickness between the tracks of the inner ring that is less than the wall thickness of the inner ring at the tracks of the inner ring.

28. Bearing arrangement as claimed in claim 17, wherein the inner ring possesses an outside diameter between the tracks of the inner ring that is less than the outside diameter of the inner ring at the tracks of the inner ring.

29. Bearing arrangement as claimed in claim 17, wherein the inner ring possesses a wall thickness axially outside the tracks of the inner ring that is less than the wall thickness of the inner ring at the tracks of the inner ring.

30. Bearing arrangement as claimed in claim 17, wherein the inner ring possesses an outside diameter axially outside the tracks of the inner ring that is less than the outside diameter of the inner ring at the tracks of the inner ring.

31. Bearing arrangement as claimed in claim 17, wherein the outer ring possesses a wall thickness between the tracks of the outer ring that is less than the wall thickness of the outer ring at the tracks of the outer ring.

32. Bearing arrangement as claimed in claim 17, wherein the outer ring possesses an outside diameter between the tracks of the outer ring that is less than the outside diameter of the outer ring at the tracks of the outer ring.

33. Bearing arrangement as claimed in claim 17, wherein the cylindrical roller bearing is located with axial play on the respective track of the outer ring.

34. Bearing arrangement as claimed in claim 33, wherein the axial play is between 0.1 mm and 0.3 mm.

35. Pedal crank bearing arrangement or hub bearing arrangement in a bicycle comprising:
an inner ring comprised of a one-piece integrally formed tubular member possessing first and second tracks;
an outer ring comprised of a one-piece integrally formed tubular member possessing first and second tracks;
the inner ring being positioned radially inwardly of the outer ring;
a first antifriction bearing between the inner and outer rings and positioned in the first track of the inner ring and the first track of the outer ring so as to be;
a second antifriction bearing between the inner and outer rings and positioned in the second track of the inner ring and the second track of the outer ring;
the first and second antifriction bearings being axially spaced apart from one another;
the first antifriction bearing being a ball bearing; and
the second antifriction bearing being a cylindrical roller bearing.

36. Bearing arrangement as claimed in claim 35, wherein the inner ring possesses a wall thickness at the first and second tracks of the inner ring that is greater than the wall thickness of the inner ring between the first and second tracks of the inner ring.
